(19) United States
(12) Patent Application Publication
(10) Pub. No.: US 2006/0127841 A1
(43) Pub. Date: Jun. 15, 2006

(54) Insertion element for a medical handpiece head

(75) Inventor: Gunter Teufelberger, Buermoos (AT)

Correspondence Address: KLARQUIST SPARKMAN, LLP, 121 SW SALMON STREET, SUITE 1600, PORTLAND, OR, 97204, US

(73) Assignee: W & H Dentalwerk Burmoos GmbH

(21) Appl. No.: 11/298,166

(22) Filed: Dec. 8, 2005

(30) Foreign Application Priority Data
Dec. 14, 2004 (AT) 2093/2004

(51) Int. Cl. A61C 1/12

(52) U.S. Cl. 433/82

(57) ABSTRACT

An insertion element that can be inserted into a medical handpiece head and can receive at least one spray medium. The insertion element comprises a bearing seat for a bearing and a lateral surface. The lateral surface has at least one ring groove which is connectable to a media line for transfer of a spray medium. The insertion element is made of resilient or elastically compressible material that can be fit within the handpiece head.

### CROSS REFERENCE TO RELATED APPLICATION

The present application claims priority from pending Austrian Patent Application No. 2093/2004, filed Dec. 14, 2004, which is incorporated herein by reference.

### BACKGROUND OF THE INVENTION

1. Field

The present invention relates to an insertion element for a medical handpiece head for dispensing a treatment spray.

2. Description of Prior Art

Such an insertion element made of metal is known from European Patent 109 507 A1, for example. It is held in the interior of the handpiece head with its tool end protruding out of the head. A first ring groove runs around the lateral surfaces of the insertion element; a media line carrying the spray liquid opens into this first groove. There is also a second ring groove into which a media line carrying the spray air opens. Boreholes run from these two ring grooves through the insertion element up to the workpiece end of the surface of the insertion element, from which the spray liquid and spray air are dispensed onto the tool and the treatment site.

The insertion element is connected by press fit to the outer raceway of the ball bearing. Also known are other insertion elements which are attached to the handpiece head by gluing or screw connections. The ball bearing is accommodated in a shoulder of the insertion element and is prestressed by spring washers (not described in European Patent 109 507 A1). Multiple O-rings seal the ring grooves and media lines with respect to the interior of the handpiece head.

### SUMMARY

One goal is to improve upon an insertion element for a medical handpiece head. The goal in particular is to reduce the additional components required (O-rings, spring washers) and to simplify installation of the insertion element in the handpiece head.

This goal is achieved by an insertion element having the features as described and claimed.

Since the insertion element is manufactured of an elastically compressible material, preferably plastic or rubber, especially preferably silicone, it may also assume additional functions, so that it serves one or more of the following purposes in particular:
to receive and mix the spray media (spray liquid, spray air) and create the treatment spray,
to hold, secure and support the roller bearing which supports the tool receptacle of the handpiece head,
to seal the cannulas, mixing chambers, etc. for the spray media,
to prestress the roller bearing (depending on the elasticity of the material selected).

Thus, in an advantageous manner, no sealing elements or spring elements are needed. Installation in the handpiece head is also facilitated by the fact that, in contrast with the previous insertion elements, it is no longer necessary to have adhesive bonds or screw connections in the handpiece head.

The insertion element preferably has a cylindrical or cylindrical-conical outside shape and therefore conforms to the internal geometry of the outside sleeve of the handpiece head and is adapted to its shape and dimensions, respectively. Owing to the elastic material properties and the radial elasticity in particular, the insertion element undergoes a radial broadening (enlargement of diameter) when the roller bearing is inserted into the insertion element, thereby pressing it with its inside lateral surface against the inside of the outside sleeve of the handpiece head and clamping it in the handpiece head. Therefore, a strong sealing effect is additionally achieved, so there is no risk of spray air or spray fluid escaping.

In a particularly preferred exemplary embodiment, the spray plate for dispensing the spray is also made of an elastically compressible material, preferably plastic or rubber, especially preferably silicone. This further reduces the assembly complexity for the handpiece head in particular. In addition, calcium deposits are automatically loosened from the spray plate when it is undergoes deformation due to applied pressure.

### BRIEF DESCRIPTION OF THE DRAWINGS

FIG. 1 shows a handpiece head with a first embodiment of the insertion element.

FIG. 2 shows a handpiece head with a second embodiment of the insertion element.

FIG. 3 shows a perspective view of the insertion element.

FIG. 4 shows a sectional diagram of the insertion element.

FIG. 5 shows a sectional view of an embodiment of the insertion element having a supporting or reinforcing element.

FIG. 6 shows a sectional view of an embodiment of the insertion element having a spring element.

### DETAILED DESCRIPTION OF THE PREFERRED EMBODIMENTS

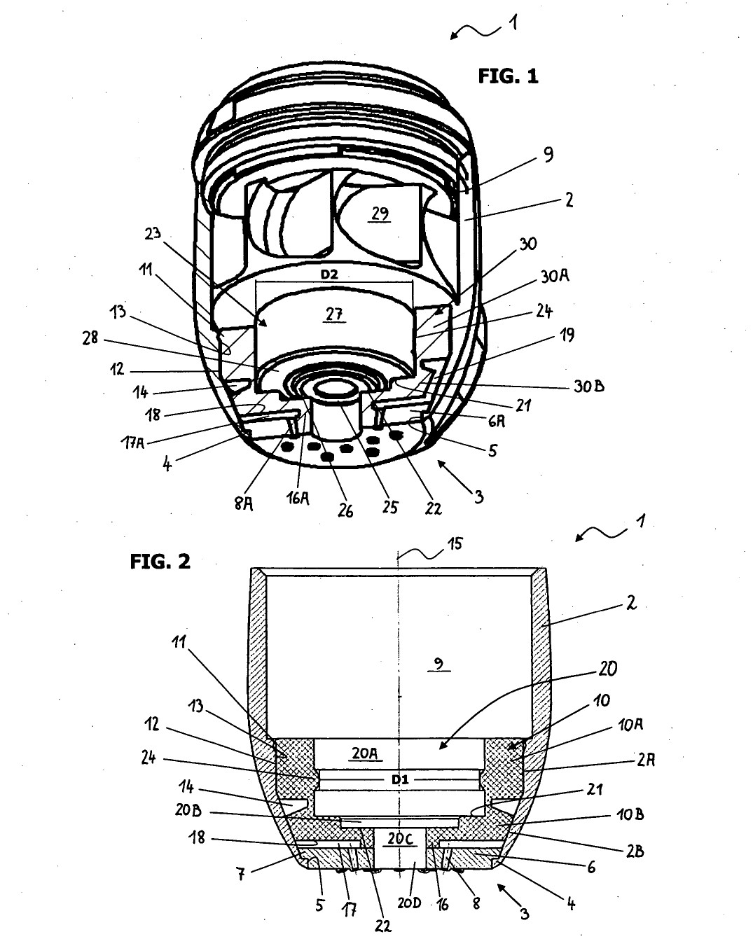

The handpiece head 1 shown in FIG. 2 is part of an angled medical handpiece (contra angle handpiece) which is known from various medical applications. The handpiece contains a turbine 29 (see FIG. 1) which is set in rotation by compressed air. The turbine 29 is connected to a tool receptacle into which a tool such as a dental drill is inserted and caused to rotate by the turbine 29. The handpiece head 1 consists of an outer sleeve 2 having a shoulder 4 on its tool-side end 3. A flat circular spray plate 6 made of plastic or metal is inserted into the opening 5 in the handpiece head 1. Spray plate 6 has on its back side a flange 7 which is in contact with the shoulder 4, so that the spray plate 6 is mounted and positioned in the opening 5. The spray plate 6 has multiple boreholes 8 passing through it, the spray (mixture of spray liquid and spray air) being dispensed through these boreholes to the treatment site and a tool inserted into the tool receptacle in the handpiece head 1. The boreholes 8 preferably have a slight inclination in the direction of the central axis 15, so that when spray liquid is dispensed, it is directed at the tool. If there are multiple boreholes 8, they may have different inclinations to ensure that when using tools of different lengths, spray liquid is dispensed precisely onto the tip of the tool and the treatment site surrounding it.

An insertion element 10 is arranged in the interior 9 of the handpiece head 1 adjacent to the spray plate 6. The insertion element 10 consists of an elastically compressible material, preferably plastic or rubber, especially preferably silicone. The outer shape of the insertion element 10 is adapted to the inside geometry of the outer sleeve 2 of the handpiece head 1. It has a cylindrically shaped section 10A according to the cylindrically shaped section 2A of the inside wall 13 of the outer sleeve 2 and a section 10B which tapers conically according to a conically tapering section 2B of the inside wall 13 of the outer sleeve 2.

On its lateral surface 12, the insertion element 10 has a ring bulge 11, the diameter of which is such that when the insertion element 10 is inserted into the handpiece head 1, the ring bulge 11 is in sealing contact with the inside wall 13 of the outer sleeve 2, thereby preventing the penetration of spray liquid and spray air into the area of the interior 9 located above the insertion element 10. A ring groove 14 runs completely around the insertion element 10. A first media line, preferably a spray air line (not shown) is connected to this ring groove 14, running in a known way through the entire handpiece, and is connected to a compressed air source.

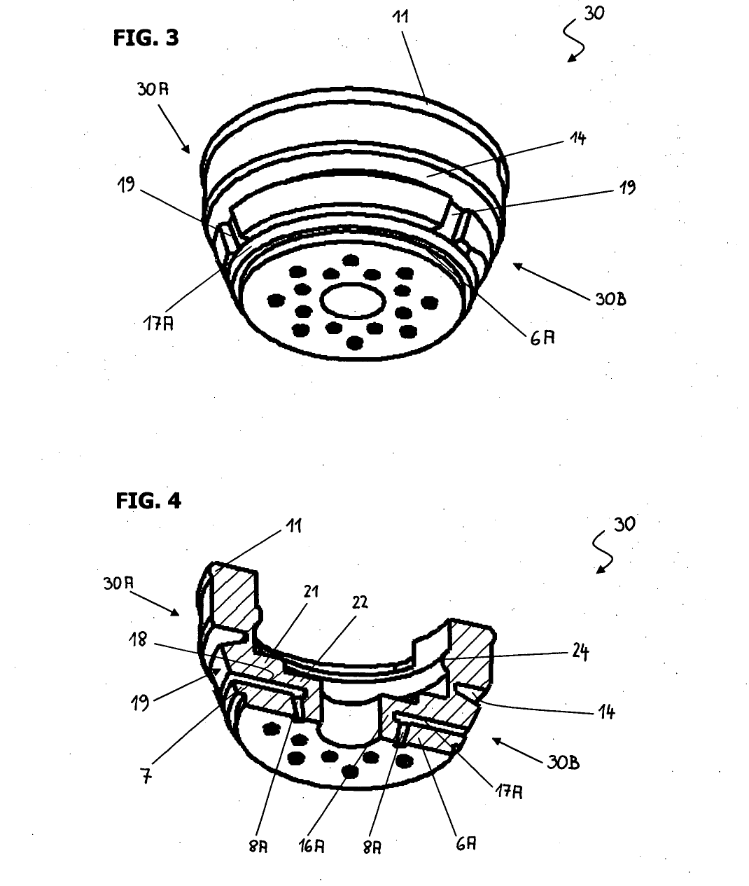

The end of the insertion element 10 facing the opening 5 is formed by a ring bulge 16 which sits directly adjacent to the spray plate 6. The ring bulge 16 creates a ring gap 17 between the spray plate 6 and the shoulder 18 of the insertion element 10. A second media line, preferably a spray liquid line (not shown) which also runs in a known way through the entire handpiece and is connected to a spray liquid source, preferably a connection to a water line, opens into this gap 17. Ring gap 17 and ring groove 14 are interconnected by one or more connecting channels 19 (see FIGS. 1, 3 and 4). During operation of the handpiece, the spray air flows from ring groove 14 through connecting channel 19 into the gap 17 where it mixes with the spray liquid. Ring gap 17 thus also functions as a mixing chamber for the spray, consisting of spray liquid and spray air, to be dispensed. The spray is then discharged to the outside through the boreholes 8, which open at one of their ends into the ring gap 17.

The interior 20 of the insertion element 10 includes three sections 20A, 20B and 20C separated from one another by two shoulders 21 and 22. Section 20A serves to accommodate a bearing 23, preferably a roller bearing/ball bearing (see FIG. 1) and forms a bearing seat with shoulder 21. The bearing 23 supports the rotating chuck 25 in a known way for detachably holding and securing the treatment tool and the spindle 26, which also rotates, and on which the turbine 29 is situated. Ball bearing 23 is secured by a ring bulge 24 which protrudes into the interior 20 of the insertion element 10. The diameter D1 of the interior section 20A is somewhat smaller in the area of the ring bulge 24 than the outside diameter D2 on the ball bearing 23. This ensures a secure mounting of the ball bearing 23 in the insertion element 10. At the same time, the insertion of the bearing 23 into the bearing seat 20A, 21 causes a radial widening (increase in diameter) of the insertion element 10 due to the elastic material properties and in particular the radial elasticity, so the insertion element 10 is pressed tightly with its lateral surface 12 against the inside 13 of the outer sleeve 2 and is clamped in the handpiece head 1. This additionally achieves a strong sealing effect, so there is no risk of spray air or spray liquid escaping from the ring groove 14 or the gap 17.

As shown in FIG. 1 in particular, the outer raceway 27 is supported directly on the shoulder 21 of the insertion element 10 as a nonmoving part of the roller bearing 23 together with a covering disk 28. The rotating inner raceway of the ball bearing 23 (not shown) as well as the tool receptacle which is also rotating (chuck 25, spindle 26) are spaced a distance apart from the shoulder 22 due to the section 20B of the insertion element 10, so there is no contact between the moving and nonmoving components.

The sections 20A, 20B and 20C of the interior 20 also form a bushing to receive the tool shaft and at least some parts of the tool receptacle (chuck 25, spindle 26). The bushing is continued in a bore 20D which passes through the spray plate.

The insertion element 30 shown in FIGS. 1, 3 and 4 resembles the insertion element 10 in design and function, so it is not necessary to describe the same components again. In contrast with insertion element 10, however, the spray plate 6A in the case of insertion element 30 is designed as part of the insertion element 30 and is also made of an elastically compressible material, preferably plastic or rubber, especially preferably silicone. Spray plate 6A is connected by a web 16A to the sections 30A and 30B of the insertion element 30. A ring groove 17A between the spray plate 16A and the shoulder 18 holds a medium, preferably the spray liquid from a media line and at the same time also serves as a mixing chamber. Multiple boreholes 8A for dispensing the spray pass through the spray plate 6A and open in the ring groove 17A. The boreholes 8A preferably have a slight inclination in the direction of the central axis 15, so the spray liquid discharged is directed at the tool. If there are multiple boreholes 8A, they may have different inclinations to ensure that spray liquid will be discharged exactly toward the tip of the tool and the treatment site surrounding it when using tools of different lengths. The spray plate 6A is positioned and supported in the opening 5 of the handpiece head 1 in the same way as the spray plate 6 by means of a flange 7 which is in contact with the shoulder 4 of the outer sleeve 2.

In other exemplary embodiments, one or more supporting and reinforcing elements, preferably supporting rings, half shells or bushings made of metal or hard plastic are arranged in the insertion element 10, 30, increasing the stability of the insertion element 10, 30. These elements may be inserted into recesses (grooves, indentations) in the insertion element 10, 30 after the manufacture of the insertion element 10, 30 (preferably by an injection molding process) or they may be accommodated in the insertion element 10, 30, preferably completely, when inserted into the injection mold before their manufacture.

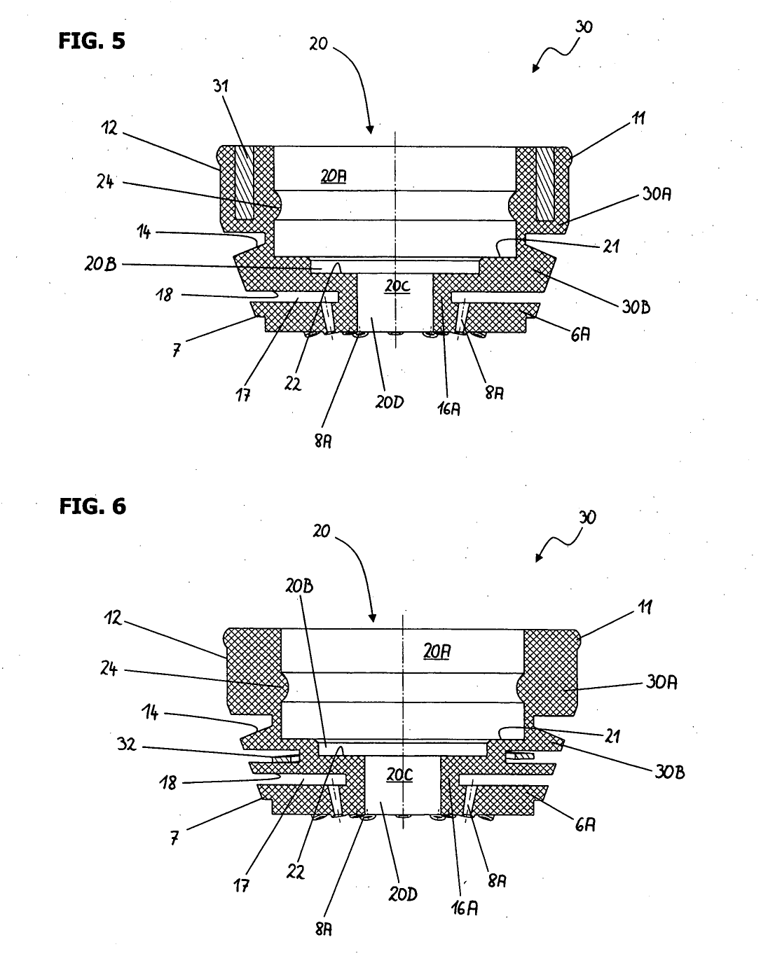

The prestress for the bearing 23 is increased by inserting a spring element, such as a spring washer 32 as shown in FIG. 6, into an additional groove in the insertion element 10, 30 below the bearing seat 20A, 21 of the bearing 23. FIG. 5 shows an embodiment comprising a washer or bushing 31 within the insertion element 30, which may be positioned as shown to at least partially surround the section 20A.

The present invention is not limited to the area of use defined here or to the specific embodiments described here but instead includes all possible embodiments which do not alter the basic function principle of the present invention.

What is claimed is:

1. An insertion element that can be inserted into a medical handpiece head to accommodate a bearing and at least one part of the tool receptacle and to receive at least one spray medium, the insertion element comprising a bearing seat for a bearing and a lateral surface with at least one ring groove which is connectible to a media line for transfer of the spray medium, wherein the insertion element is made of an elastically compressible material.

2. The insertion element according to claim 1, wherein the at least one spray medium is a first medium, the at least one ring groove is a first ring groove and the media line is a first media line, and wherein the insertion element comprises a second ring groove which is connectible to a second media line for transfer of a second medium, whereby the first medium introduced into the first ring groove comprises air and the second medium introduced into the second ring groove comprises liquid.

3. The insertion element according to claim 1 further comprising at least one connecting channel capable of connecting the ring groove to a spray plate.

4. The insertion element according to claim 2, further comprising a connecting channel connecting the first ring groove to the second ring groove.

5. The insertion element according to claim 1, wherein the insertion element conforms to an inside geometry of an outer sleeve of the handpiece head.

6. The insertion element according to claim 5, wherein the insertion element has a generally cylindrical section and a frustoconical section.

7. The insertion element according to claim 1, wherein the insertion element comprises an interior with several sections which are separated from one another by shoulders.

8. The insertion element according to claim 7, wherein the bearing seat is disposed in the interior and a ring bulge is provided in the bearing seat so that the diameter of the interior is smaller in the area of the ring bulge than the diameter of the bearing.

9. The insertion element according to claim 1, further comprising a ring bulge on the lateral surface of the insertion element for sealing the interior of the handpiece head adjacent to the insertion element.

10. The insertion element according to claim 1, wherein one or more spring elements, supporting elements or reinforcing elements, preferably spring washers, supporting rings, half-shells or bushings made of metal or hard plastic, are arranged in the insertion element.

11. The insertion element claim 1, wherein the insertion element has a radial elasticity causing a bearing inserted into the bearing seat to press the insertion element with its lateral surface in sealing contact against the inside of an outer sleeve of the handpiece head, thereby securing the insertion element in the handpiece head.

12. The insertion element according claim 1, further comprising a spray plate formed as part of the insertion element and made of an elastically compressible material.

13. The insertion element according to claim 12, further comprising a flange on the spray plate for positioning the spray plate on a shoulder of an outer sleeve of the handpiece head.

14. The insertion element according to claim 12, wherein the spray plate has at least one bore for dispensing spray, the bore having an inclination in the direction of a central axis so that the spray dispensed is directed at a tool received in the part of the tool receptacle.

15. The insertion element according to claim 13, wherein the spray plate has at least one bore for dispensing spray, the bore having an inclination in the direction of a central axis so that the spray dispensed is directed at a tool received in the part of the tool receptacle.

16. The insertion element according to claim 1, wherein the insertion element is made of plastic or rubber.

17. The insertion element according to claim 1, wherein the insertion element is made of silicone.

18. The insertion element according to claim 12, wherein the spray plate is made of plastic or rubber.

19. The insertion element according to claim 12, wherein the spray plate is made of silicone.

20. An insertion element that can be inserted into a medical handpiece head to accommodate a bearing and at least a portion of the tool receptacle and to receive at least one spray medium, the insertion element comprising a bearing seat for a bearing and a lateral surface with at least one ring groove which is connectible to a media line for transfer of the spray medium, wherein the insertion element is made of a resilient material.
